(19) United States
(12) Patent Application Publication
(10) Pub. No.: US 2026/0299390 A1
(43) Pub. Date: Oct. 1, 2026

(54) PROJECTOR AND PROJECTION SYSTEM

(71) Applicant: SEIKO EPSON CORPORATION, Tokyo (JP)

(72) Inventor: Takuo YONEYAMA, Azumino-shi (JP)

(21) Appl. No.: 19/634,623

(22) Filed: Mar. 31, 2026

(30) Foreign Application Priority Data
Apr. 1, 2025 (JP) 2025-060274

(51) Int. Cl. G03B 21/20; G03B 17/54; G03B 21/14

(52) U.S. Cl. CPC G03B 21/2073; G03B 17/54; G03B 21/142; G03B 21/2013

(57) ABSTRACT

A projector according to an aspect of the present disclosure includes a light source apparatus, a polarization separator that separates light output from the light source apparatus, a first light modulating element that modulates first polarized light separated by the polarization separator, a second light modulating element that modulates second polarized light separated by the polarization separator, a light combiner that combines the first modulated light output from the first light modulating element with the second modulated light output from the second light modulating element to generate the image light, and a projection optical apparatus that projects the image light. The first modulated light contains a first marker pattern, the second modulated light contains a second marker pattern configured with a bright and dark pattern that is a reversed version of the first marker pattern, and the light combiner combines the first modulated light and the second modulated light in a way that the first marker pattern and the second marker pattern cancel out each other in the image light.

The present application is based on, and claims priority from JP Application Serial Number 2025-060274, filed Apr. 1, 2025, the disclosure of which is hereby incorporated by reference herein in its entirety.

### BACKGROUND

### 1. Technical Field

The present disclosure relates to a projector and a projection system.

### 2. Related Art

A projector, which is an image display apparatus, modulates multiple types of light output from light sources and having different colors with light modulators in accordance with image information, combines the multiple types of modulated image light having the multiple colors with one another, and projects the combined image light onto a screen via a light projection apparatus to display an image or a video on the screen.

For example, JP-A-2013-041015 discloses a projector that modulates multiple types of color light having the three primary colors into multiple types of image light, then combines the multiple types of image light with one another, and projects the combined image light. The projector disclosed in JP-A-2013-041015 includes a first light source that outputs red light and blue light in a time division manner, and a second light source that outputs green light. In the projector, the two types of color light output from the first light source in a time division manner enter a first light modulator, are each converted into red image light or blue image light in the time division manner, which is guided to a dichroic prism. The green light output from the second light source enters a second light modulator, is converted into green image light, is guided to the dichroic prism, enters the dichroic prism via a light incident surface different from an incident surface on which the red image light or the blue image light is incident, and is combined with the red image light or the blue image. Image light into which the multiple types of color image light are combined with one another by the dichroic prism passes through a light projection apparatus, which enlarges and projects the image light.

JP-A-2007-199349 discloses a projector that divides white light into multiple types of color light, modulates the multiple types of color light into multiple types of image light, combines the multiple types of image light with one another, and then projects the combined image light. In the projector disclosed in JP-A-2007-199349, the white light output from a light source lamp or the like passes through various optical systems including a polarization converter, and is separated into green light and a combination of red light and blue light by a color separation system including a dichroic mirror. The green light is converted into green image light by a first light modulator. The polarization directions of the red light and the blue light are rotated by 90° at an appropriate timing by a polarization switcher disposed upstream of a second light modulator in the optical path of the two types of color light. Blue image light and red image light are therefore switched from one to the other in a time division manner, and are output from the second light modulator. The blue image light or the red image light output from the second light modulator and the green image light output from the first light modulator are combined with each other by a dichroic prism, and the combined image light is enlarged and projected via a light projection apparatus.

In a projector, to control a visible image to be displayed, a visible image and an invisible image such as an infrared image are superimposed on each other in some cases on a screen, and display control is performed on the visible image based on information that can be acquired from the invisible image. For example, JP-A-2008-176195 discloses a projector that separates infrared light from the light output from a light source and superimposes an invisible image on a visible image via a dedicated light modulating element.

JP-A-2013-041015, JP-A-2007-199349, and JP-A-2008-176195 are examples of the related art.

In the projector disclosed in JP-A-2013-041015 described above, since the multiple types of color light having polarization directions that are not aligned with each other enter the light modulators each including a liquid crystal panel or the like, part of each of the multiple types of color light is lost in the light modulator or a polarizer that is not shown but is disposed upstream of the light modulator in the optical path of the color light, so that the light use efficiency is halved. In the projector disclosed in JP-A-2007-199349 described above, the polarization separation, which is performed upstream of the light modulators, is performed substantially for color separation, so that absorption of unnecessary light results in losses of the multiple types of color light, and using the polarization converter causes complexity.

In the projector disclosed in JP-A-2008-176195 described above, since an invisible image formed by infrared light is superimposed as a marker for position determination on a projection image, an infrared light source and an optical system that combines the infrared light with visible light are separately disposed, resulting in an increase in size and weight of the configuration of the projector.

In view of the circumstances described above in relation to a projector, it is desired to provide a novel technology that allows use of multiple types of color light at a maximum efficiency to generate image light for improvement in the light use efficiency, and reduction in the number of elements to suppress an increase in size of the projector, and further allows projection image display control.

### SUMMARY

A projector according to an aspect of the present disclosure includes: a light source apparatus configured to output light; a polarization separator configured to separate the light output from the light source apparatus into first polarized light and second polarized light polarized in a direction different from a direction in which the first polarized light is polarized; a first light modulating element configured to modulate the first polarized light separated by the polarization separator; a second light modulating element configured to modulate the second polarized light separated by the polarization separator, a light combiner configured to combine first modulated light output from the first light modulating element and entering the light combiner with second modulated light output from the second light modulating element and entering the light combiner incident in a direction different from a direction in which the first modulated light enters the light combiner to generate image light; and a projection optical apparatus configured to project the image light output from the light combiner, the first modulated light being light polarized in the same direction as the second polarized light containing a first marker pattern configured with a predetermined bright and dark pattern, the second modulated light being light polarized in the same direction as the first polarized light containing a second marker pattern configured with a reversed bright and dark pattern that is a reversed version of the first marker pattern in terms of bright portions and dark portions, and the light combiner being configured to combine the first modulated light and the second modulated light with each other in a way that the first marker pattern and the second marker pattern cancel out each other in the image light.

A projection system according to another aspect of the present disclosure includes: the projector according to the aspect described above; and an imager configured to image one of the first modulated light and the second modulated light contained in the image light projected from the projector, and the projector is configured to change a shape of the first marker pattern and a position where the first marker pattern is formed in the first modulated light, and a shape of the second marker pattern and a position where the second marker pattern is formed in the second modulated light based on a result of the imaging performed by the imager.

A projection system according to another aspect of the present disclosure includes: the projector according to the aspect described above; and an imager configured to image one of the first modulated light and the second modulated light contained in the image light projected from the projector, and the projector is configured to perform predetermined image processing on the captured image based on a result of the imaging performed by the imager.

A projection system according to another aspect of the present disclosure includes: the projector according to the aspect described above; and an imager configured to image one of the first modulated light and the second modulated light contained in the image light projected from the projector, and the projector includes a moving mechanism configured to move the projection optical apparatus to change a position where the image light is projected, and a controller configured to control the moving mechanism based on an image imaged by the imager.

### BRIEF DESCRIPTION OF THE DRAWINGS

FIG. 1 is a plan view showing a schematic configuration of a projection system.

FIG. 2 shows the behavior of light output from light modulating elements.

FIG. 3 is a conceptual view showing the correspondence between first image modulated light and second image modulated light.

FIG. 4 is a table showing the relationship between the gradation of a projection image and a marker contrast.

FIG. 5 shows the relationship between the gradation of the projection image and the marker contrast.

FIG. 6 shows an example of the procedure of the operations of a projector.

### DESCRIPTION OF EMBODIMENTS

An embodiment of the present disclosure will be described below with reference to the drawings.

In the following drawings, elements may be drawn at different dimensional scales for clarity of the elements.

### First Embodiment

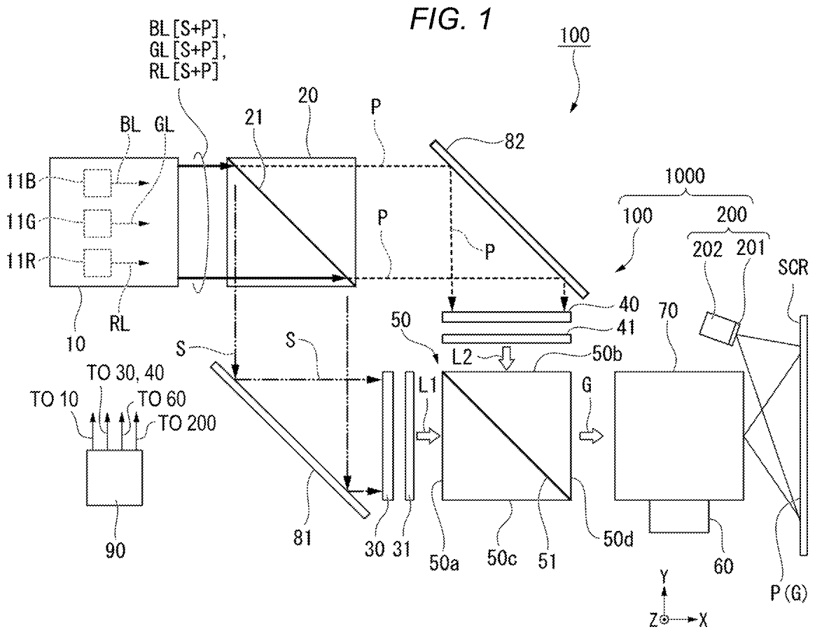

FIG. 1 is a plan view showing a schematic configuration of a projection system according to the present embodiment.

A projection system 1000 according to the present embodiment includes a projector 100 and an imager 200, as shown in FIG. 1.

The projector 100 projects a projection image onto a screen SCR disposed in front of the projector 100. The projector 100 includes a light source apparatus 10, a polarization separator 20, a first light modulating element 30, a first light-exiting-side polarizer 31, a second light modulating element 40, a second light-exiting-side polarizer 41, a light combiner 50, a shift mechanism (moving mechanism) 60, a projection optical apparatus 70, a first reflection mirror 81, a second reflection mirror 82, and a controller 90.

The configuration of the projector 100 will subsequently be described in detail.

The light source apparatus 10 includes a first light source 11B, a second light source 11G, and a third light source 11R. The light source apparatus 10 sequentially drives the first light source 11B, the second light source 11G, and the third light source 11R to output blue light BL, green light GL, and red light RL, respectively, to a +Z side in a time division manner.

In the following description, an axis parallel to the optical axis of each of the multiple types of color light BL, GL, and RL output from the light source apparatus 10 in a time division manner is called an X-axis. One side along the X-axis is called a −X side, and the side opposite the −X side along the X-axis is called a +X side.

An axis parallel to the optical axis of light output from the second reflection mirror 82 toward the second light modulating element 40 is called a Y-axis. One side along the Y-axis is called a −Y side, and the side opposite the −Y side along the Y-axis is called a +Y side. An axis orthogonal to the X-axis and the Y-axis is called a Z-axis. One side along the Z-axis is called a −Z side, and the side opposite the −Z side along the Z-axis is called a +Z side.

The first light source 11B outputs the blue light BL, which belongs to a blue wavelength band in the visible wavelength band. The blue light BL is at least non-polarized light, contains S-polarized light and P-polarized light, and is, for example, randomly polarized light. BL[S+P] in FIG. 1 represents the blue light BL containing S-polarized light and P-polarized light. The blue light BL corresponds to first light. The blue wavelength band corresponds to a first wavelength band and is, for example, a wavelength band between 420 nm and 500 nm.

The first light source 11B is a laser diode (LD) or a light emitting diode (LED) capable of emitting the blue light BL, which is non-polarized light. When an LD that emits only S-polarized or P-polarized blue light BL is used as the first light source 11B, multiple LDs having light emission ports oriented in different directions may be used, or retardation plates or wave plates that are not shown may be combined with the LDs.

The second light source 11G outputs the green light GL, which belongs to a green wavelength band different from the blue wavelength band in the visible wavelength band. The green light GL is at least non-polarized light, contains S-polarized light and P-polarized light, and is, for example, randomly polarized light. GL[S+P] in FIG. 1 represents the green light GL containing S-polarized light and P-polarized light. The green light GL corresponds to second light. The green wavelength band corresponds to a second wavelength band and is, for example, a wavelength band between 520 nm and 600 nm. The second light source 11G is an LD or an LED capable of emitting the green light GL, which is non-polarized light. When an LD that emits only S-polarized or P-polarized green light GL is used as the second light source 11G, multiple LDs having light emission ports oriented in different directions may be used, or retardation plates or wave plates that are not shown may be combined with the LDs.

The third light source 11R outputs the red light RL, which belongs to a red wavelength band different from the blue wavelength band and the green wavelength band in the visible wavelength band. The red light RL is at least non-polarized light, contains S-polarized light and P-polarized light, and is, for example, randomly polarized light. RL[S+P] in FIG. 1 represents the red light RL containing S-polarized light and P-polarized light. The red light RL corresponds to third light. The red wavelength band corresponds to a third wavelength band and is, for example, a wavelength band between 650 nm and 780 nm. The third light source 11R is an LD or an LED capable of emitting the red light RL, which is non-polarized light. When an LD that emits only S-polarized or P-polarized red light RL is used as the third light source 11R, multiple LDs having light emission ports oriented in different directions may be used, or retardation plates or wave plates that are not shown may be combined with the LDs.

The polarization separator 20 is disposed on the +X side of the light source apparatus 10. The polarization separator 20 separates the S-polarized light and the P-polarized light contained in each of the incident blue light BL, green light GL, and red light RL, and outputs the S-polarized light and the P-polarized light of each of the multiple types of color light in different directions. The S-polarized light, which is one of the S-polarized light and the P-polarized light, corresponds to first polarized light, and is labeled as “S” in FIG. 1. The P-polarized light, which is the other of the S-polarized light and the P-polarized light, corresponds to second polarized light, and is labeled as “P” in FIG. 1. The P-polarized light may correspond to the first polarized light, the S-polarized light may correspond to the second polarized light, and configurations to be described later may be arranged as appropriate in correspondence with the above assignments.

The polarization separator 20 is, for example, a cube-shaped polarizing beam splitter, and includes a first polarization separation film 21. The first polarization separation film 21 is disposed so as to extend from the −X side toward the +X side as extending from the +Y side to the −Y side, transmits the P-polarized light of each of the incident blue light BL, green light GL, and red light RL, and reflects the S-polarized light of each of the incident blue light BL, green light GL, and red light RL. The polarization separator 20 transmits the P-polarized light of each of the blue light BL, the green light GL, and the red light RL incident from the −X side, outputs the P-polarized light toward the +X side, reflects the S-polarized light of each of the blue light BL, the green light GL, and the red light RL incident as described above, and outputs the S-polarized light toward the −Y side. The polarization separator 20 thus separates the light output from the light source apparatus 10 into the P-polarized light, which is the first polarized light, and the S-polarized light, which is the second polarized light and is polarized in a direction different from the direction in which the first polarized light is polarized.

The first reflection mirror 81 is disposed in the optical path of the S-polarized light of each of the blue light BL, the green light GL, and the red light RL output from the polarization separator 20. The first reflection mirror 81 is disposed at a position shifted from the polarization separator 20 toward the −X side. The reflection surface of the first reflection mirror 81 is disposed so as to extend from the −X side toward the +X side as extending from the +Y side toward the −Y side, and reflects the S-polarized light of each of the blue light BL, the green light GL, and the red light RL. The first reflection mirror 81 reflects the S-polarized light of each of the blue light BL, the green light GL, and the red light RL incident from the +Y side toward the first light modulating element 30, and outputs the S-polarized light toward the +X side.

The second reflection mirror 82 is disposed in the optical path of the P-polarized light of each of the blue light BL, the green light GL, and the red light RL output from the polarization separator 20. The second reflection mirror 82 is disposed at a position shifted from the polarization separator 20 toward the +X side. The reflection surface of the second reflection mirror 82 is disposed so as to extend from the −X side toward the +X side as extending from the +Y side toward the −Y side, and reflects the P-polarized light of each of the blue light BL, the green light GL, and the red light RL. The second reflection mirror 82 reflects the P-polarized light of each of the blue light BL, the green light GL, and the red light RL incident from the −X side toward the second light modulating element 40, and outputs the P-polarized light toward the −Y side.

The first light modulating element 30 is disposed in the optical path of the S-polarized light of each of the blue light BL, the green light GL, and the red light RL output from the first reflection mirror 81. The first light modulating element 30 modulates the S-polarized light of the blue light BL, the green light GL, and the red light RL incident in a time division manner based on image information.

The first light modulating element 30 is, for example, a transmissive liquid crystal panel. The liquid crystal panel that constitutes the first light modulating element 30 has a light modulation surface parallel to the YZ plane. The light modulation surface of the liquid crystal panel that constitutes the first light modulating element 30 has a rectangular shape when viewed along the X direction, and is an image display region where multiple pixels that are not shown are arranged. The pixels each modulate the blue light BL, the green light GL, and the red light RL incident from the first reflection mirror 81 based on the image information to generate first blue image light, first green image light, and first red image light in a time division manner. The first blue image light, the first green image light, and the first red image light output in a time division manner by the first light modulating element 30 each correspond to first image modulated light (first modulated light) L1.

The first light-exiting-side polarizer 31 is disposed between the first light modulating element 30 and the light combiner 50. The first light-exiting-side polarizer 31 is disposed in the optical path of the first image modulated light L1 output from the first light modulating element 30, transmits the P-polarized light out of the first image modulated light L1, and absorbs or reflects the polarized light excluding the P-polarized light out of the first image modulated light L1 toward the −X side. The S-polarized light of the first image modulated light L1, which has not been modulated by the first light modulating element 30, is thus blocked by the first light-exiting-side polarizer 31.

The configuration described above allows the P-polarized light of the first image modulated light L1 to efficiently enter the light combiner 50. The contrast ratio of the first image modulated light L1 can therefore be improved.

The second light modulating element 40 is disposed in the optical path of the P-polarized light of each of the blue light BL, the green light GL, and the red light RL output from the second reflection mirror 82. The second light modulating element 40 modulates the P-polarized light of the blue light BL, the green light GL, and the red light RL incident in a time division manner based on image information.

The second light modulating element 40 is, for example, a transmissive liquid crystal panel. The liquid crystal panel that constitutes the second light modulating element 40 has a light modulation surface parallel to the XZ plane. The light modulation surface of the liquid crystal panel that constitutes the second light modulating element 40 has a rectangular shape when viewed along the Y direction, and is an image display region where multiple pixels that are not shown are arranged. The pixels each modulate the blue light BL, the green light GL, and the red light RL incident from the second reflection mirror 82 based on the image information to generate second blue image light, second green image light, and second red image light in a time division manner. The second blue image light, the second green image light, and the second red image light output in a time division manner by the second light modulating element 40 each correspond to second image modulated light (second modulated light) L2.

The second light-exiting-side polarizer 41 is disposed between the second light modulating element 40 and the light combiner 50. The second light-exiting-side polarizer 41 is disposed in the optical path of the second image modulated light L2 output from the second light modulating element 40, transmits the S-polarized light out of the second image modulated light L2, and absorbs or reflects the polarized light excluding the S-polarized light out of the second image modulated light L2 toward the +Y side. The P-polarized light of the second image modulated light L2, which has not been modulated by the second light modulating element 40, is thus blocked by the second light-exiting-side polarizer 41.

The configuration described above allows the S-polarized light of the second image modulated light L2 to efficiently enter the light combiner 50. The contrast ratio of the second image modulated light L2 can therefore be improved.

In the projector 100 according to the present embodiment, the timing at which the first light modulating element 30 modulates the S-polarized light of the blue light BL, the green light GL, and the red light RL coincides with the timing at which the second light modulating element 40 modulates the P-polarized light of the blue light BL, the green light GL, and the red light RL. The projector 100 according to the present embodiment can therefore readily control the timing at which the blue light BL, the green light GL, and the red light RL are output from the light source apparatus 10 and the timing at which the blue image light, the green image light, and the red image light are output from the first light modulating element 30 and the second light modulating element 40. The projector 100 according to the present embodiment can therefore realize full-color display in a time division manner using two light modulating elements.

Note that the operation mode of the liquid crystal panels that constitute the first light modulating element 30 and the second light modulating element 40 is not limited to a specific mode, and may be any of a TN mode, a VA mode, a lateral electric field mode, and the like.

The light combiner 50 is disposed in a region where the optical path of the first image modulated light L1 output from the first light modulating element 30 in a time division manner intersects with the optical path of the second image modulated light L2 output from the second light modulating element 40 in a time division manner.

The light combiner 50 is, for example, a cube-shaped beam splitter, and includes a second polarization separation film 51. The second polarization separation film 51 is disposed so as to extend from the −X side toward the +X side as extending from the +Y side toward the −Y side.

The light combiner 50 has a first side surface 50a, a second side surface 50b, a third side surface 50c, and a fourth side surface 50d. The first side surface 50a is a surface along the YZ plane, and is a surface which faces the first light modulating element 30 and on which the first image modulated light L1 is incident. The second side surface 50b is a surface along the XZ plane, and is a surface which faces the second light modulating element 40 and on which the second image modulated light L2 is incident. The third side surface 50c is a surface different from the first side surface 50a and the second side surface 50b, intersects with the first side surface 50a, is parallel to the second side surface 50b, and faces the side opposite the second side surface 50b (−Y side). The fourth side surface 50d is a surface different from any of the first side surface 50a to the third side surface 50c, intersects with the second side surface 50b and the third side surface 50c, is parallel to the first side surface 50a, and faces the side opposite the first side surface 50a (+X side).

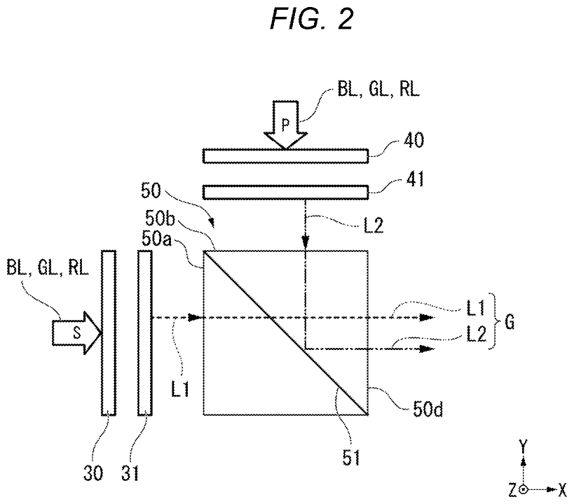

FIG. 2 shows the behavior of the light output from the first light modulating element 30 and the second light modulating element 40.

The first image modulated light L1 output from the first light modulating element 30 corresponds to P-polarized light with respect to the second polarization separation film 51, as shown in FIG. 2. The second image modulated light L2 output from the second light modulating element 40 corresponds to S-polarized light with respect to the second polarization separation film 51.

The second polarization separation film 51 of the light combiner 50 combines the first image modulated light L1 and the second image modulated light L2 with each other to generate image light G. The second polarization separation film 51 transmits the first image modulated light L1, which is the P-polarized light, and reflects the second image modulated light L2, which is the S-polarized light.

Specifically, the light combiner 50 transmits the first image modulated light L1, which is the P-polarized light incident via the first side surface 50a, toward the fourth side surface 50d, and reflects the second image modulated light L2, which is the S-polarized light incident via the second side surface 50b, toward the fourth side surface 50d. The light combiner 50 can therefore output the image light G, which is the combination of the first image modulated light L1 and the second image modulated light L2, via the fourth side surface 50d.

The image light G output via the fourth side surface 50d of the light combiner 50 enters the projection optical apparatus 70. The projection optical apparatus 70 enlarges the image light G incident from the light combiner 50, and projects the enlarged image light G toward the screen SCR, which is a projection receiving surface. The projection optical apparatus 70 is configured, for example, with one or more optical lenses. Examples of the optical lenses may include a variety of lenses, such as a planoconvex lens, a biconvex lens, a meniscus lens, an aspherical lens, a rod lens, and a freeform surface lens.

The projector 100 according to the present embodiment thus displays the image light G as a projection image P on the screen SCR.

The shift mechanism 60 is electrically coupled to the controller 90, which will be described later. The shift mechanism 60 receives an electric signal from the controller 90, and moves the projection optical apparatus 70. The projector 100 according to the present embodiment can thus change the position of the projection image P on the screen SCR.

The imager 200 images the projection image P projected onto the screen SCR by the projector 100. The projection image P is formed by the image light G, which is the combination of the first image modulated light L1 and the second image modulated light L2, which are polarized in different directions as described above. The imager 200 acquires a predetermined pattern from the result of the operation of imaging the projection image P as will be described later.

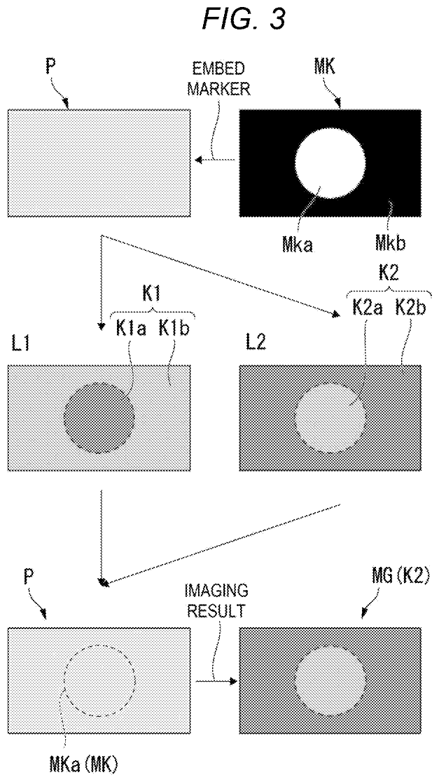

The projection image P imaged by the imager 200 will now be described. FIG. 3 is a conceptual view showing the configuration of the projection image P.

In FIG. 3, to simplify the description, it is assumed that the projection image P is, for example, an image in which a marker pattern MK containing one large circle is formed at the center of an entirely 80%-gradation gray image. Hereinafter, in the marker pattern MK, a portion corresponding to a central circle may be referred to as a marker portion MKa, and the portion excluding the central circle may be referred to as a non-marker portion MKb.

A first marker pattern K1 includes a first marker portion K1a corresponding to the marker portion MKa of the marker pattern MK and a first non-marker portion K1b corresponding to the non-marker portion MKb of the marker pattern MK, as shown in FIG. 3.

The first light modulating element 30 performs modulation to form first image modulated light L1 containing the first marker pattern K1 configured with a predetermined bright and dark pattern by adjusting the amount of light modulation performed by the liquid crystal panel in a way that a 30%-gradation gray image darker than the projection image P is generated in the first marker portion K1a and a 50%-gradation gray image darker than the projection image P is generated in the first non-marker portion K1b.

A second marker pattern K2 includes a second marker portion K2a corresponding to the marker portion MKa of the marker pattern MK and a second non-marker portion K2b corresponding to the non-marker portion MKb of the marker pattern MK.

The second light modulating element 40 performs modulation to form second image modulated light L2 containing the second marker pattern K2 by adjusting the amount of light modulation performed by the liquid crystal panel in a way that a 50%-gradation gray image darker than the projection image P is generated in the second marker portion K2a and a 30%-gradation gray image darker than the projection image P is generated in the second non-marker portion K2b.

When the first marker pattern K1 contained in the first image modulated light L1 and the second marker pattern K2 contained in the second image modulated light L2 are compared with each other, the gray gradation of the first marker portion K1a and the gray gradation of the second non-marker portion K2b coincide with each other, and the gray gradation of the first non-marker portion K1b and the gray gradation of the second marker portion K2a coincide with each other. It can therefore be said that the second marker pattern K2 and the first marker pattern K1 have a reversed bright and dark pattern relationship in which the bright portions and the dark portions are reversed.

The light combiner 50 combines the first image modulated light L1 and the second image modulated light L2 with each other in a way that the 30%-gradation first marker portion K1a and the 50%-gradation second marker portion K2a are superimposed on each other in a region of the image light G that is the region corresponding to the marker portion MKa of the marker pattern MK. The marker portion MKa of the marker pattern MK, which is the portion where the first marker portion K1a and the second marker portion K2a are superimposed on each other, has a 80% gradation, which is the same as the gray gradation of the projection image P, so that it is difficult to distinguish the marker portion MKa from the projection image P. That is, it can also be said that the marker portion MKa of the marker pattern MK is embedded in the projection image P.

Similarly, the light combiner 50 combines the first image modulated light L1 and the second image modulated light L2 with each other in a way that the 50%-gradation first non-marker portion K1b and the 30%-gradation second non-marker portion K2b are superimposed on each other in a region of the image light G that is the region corresponding to the non-marker portion MKb of the marker pattern MK. The non-marker portion MKb of the marker pattern MK, which is the portion where the first non-marker portion K1b and the second non-marker portion K2b are superimposed on each other, has the 80% gradation, which is the same as the gray gradation of the projection image P, so that it is difficult to distinguish the non-marker portion MKb from the projection image P. That is, it can also be said that the non-marker portion MKb of the marker pattern MK is embedded in the projection image P.

In the projector 100 according to the present embodiment, the light combiner 50 combines the first image modulated light L1 and the second image modulated light L2 of the image light G with each other in a way that the first marker pattern K1 and the second marker pattern K2 cancel out each other. That is, the light combiner 50 combines the first image modulated light L1 and the second image modulated light L2 with each other in a way that the marker pattern MK, which is the combination of the first marker pattern K1 and the second marker pattern K2, has the same gray gradation as the projection image P, so that it is difficult to distinguish the circular marker portion MKa of the marker pattern MK from the projection image P.

The projector 100 according to the present embodiment can therefore prevent the user from visually recognizing the marker pattern MK embedded in the projection image P even when a user is visually recognizing the projection image P. The projector 100 according to the present embodiment therefore does not cause the user visually recognizing the projection image P to see unnecessary information and can therefore prevent the user from feeling something is wrong.

The imager 200 in the present embodiment includes a polarizer 201, which transmits one of the first image modulated light L1 and the second image modulated light L2 contained in the image light G, which constitutes the projection image P, and a camera 202 including an imaging element capable of imaging modulated light having passed through the polarizer 201. The imager 200 can therefore image the marker pattern contained in the one image modulated light having passed through the polarizer 201. The imager 200 in the present embodiment causes the camera 202 to image, for example, the second marker pattern K2 contained in the second image modulated light L2 passing through the polarizer 201 as a marker image MG, as shown in FIG. 3. Note that the imager 200 may employ a configuration in which the polarizer 201 transmits the first image modulated light L1 and the camera 202 images the first image modulated light L1 as the marker image.

The imager 200 is disposed outside the projector 100, is connected to the projector 100 in a wired or wireless manner, and is disposed at a place where the imager 200 does not block the light projected from the projector 100. Note that the imager 200 may instead be incorporated in the projector 100.

The imager 200 is electrically coupled to the controller 90 of the projector 100. The projector 100 causes the shift mechanism 60 to correct the projection position of the projection image P based on the image captured by the imager 200, as will be described later.

The controller 90 is configured, for example, with a computer or an integrated circuit including a built-in program that operates drivers that drive the imager 200, the shift mechanism 60, the light source apparatus 10, the first light modulating element 30, and the second light modulating element 40. The controller 90 is, for example, a processor. The controller 90 is connected to each of the imager 200, the shift mechanism 60, the light source apparatus 10, the first light modulating element 30, and the second light modulating element 40 via a wire that is not shown or wirelessly.

To improve the identifiability of the marker pattern MK in the marker image MG captured by the imager 200, it is effective to increase the marker contrast of the first marker pattern K1 or the second marker pattern K2. The above description with reference to FIG. 3 has been made with reference to the case where the projection image P is set to be a 80%-gradation gray image, but the gradation of the projection image P is not limited to 80%, and it is desirable to change the marker contrast described above in accordance with the gradation of the projection image P.

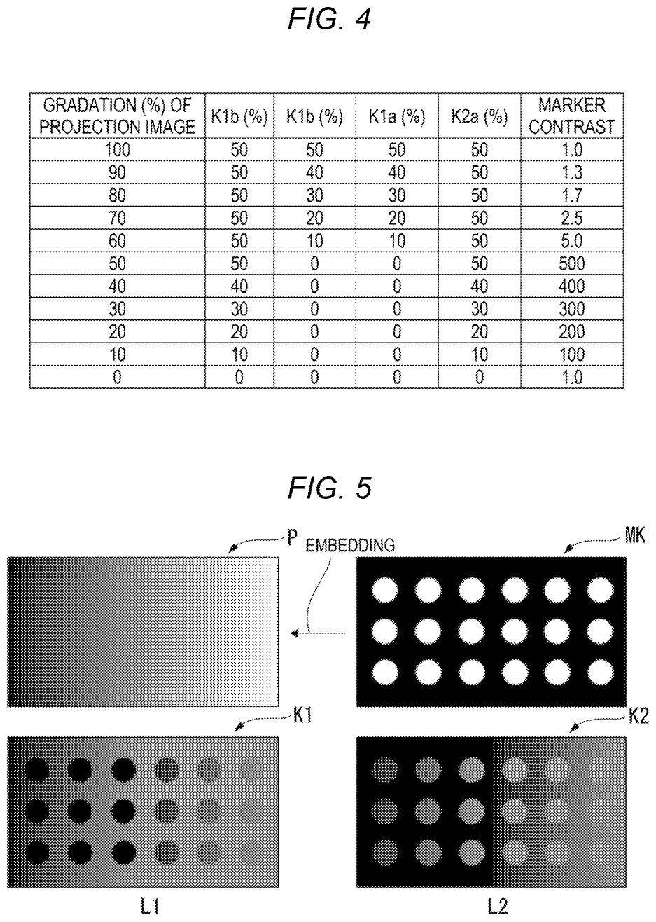

The relationship between the gradation of the projection image P and the marker contrast will be described below. FIG. 4 is a table showing the relationship between the gradation of the projection image P and the marker contrast. FIG. 4 shows the gradations of the first marker portion K1a, the first non-marker portion K1b, the second marker portion K2a, and the second non-marker portion K2b versus the gradation of the projection image P changed over a range between 100% and 0%. Note in the projector 100 according to the present embodiment that the maximum gradation achieved by each of the first light modulating element 30 and the second light modulating element 40 is 50%, and that the maximum gradation being 50% allows a 100%-gradation projection image P. For example, in the case of the polarizer 201, assuming that the degree of polarization achieved by a P-polarized light blocking filter is 1000:1 and the gradation (%) of the projection image is 50, the marker contrast is as follows: 50% at the marker bright portion; and 0.1% at the marker dark portion. In this case, the marker contrast is 500:1. That is, to display a projection image having a gradation greater than or equal to 50%, the light is output from both the first light modulating element 30 and the second light modulating element 40, but to display a projection image having a gradation smaller than 50%, the light only needs to be output from only one of the first light modulating element 30 and the second light modulating element 40.

In the table shown in FIG. 4, to simplify the description, it is assumed that the entire projection image P has the same gradation, for example, an image displayed in entirely white, an image displayed in entirely black, an image displayed in entirely gray, or the like.

When a 100%-gradation entirely white projection image is projected, it is necessary to set the gradation achieved by each of the first light modulating element 30 and the second light modulating element 40 to the maximum value, that is, 50% gradation, as shown in FIG. 4. For example, when the gradation achieved by the first light modulating element 30 is set to 50%, to set the difference in gradation between the first marker portion K1a and the first non-marker portion K1b, which constitute the first marker pattern K1, it is necessary to compensate for the gradation achieved by the second light modulating element 40, which displays the second marker pattern K2, to maintain the 100% gradation of the projection image P. However, since the maximum gradation achieved by the second light modulating element 40 is similarly 50%, the gradation achieved by the second light modulating element 40 cannot be set to 50% or greater, so that the 100% gradation of the projection image P cannot be maintained. That is, when the projector 100 according to the present embodiment projects a 100%-gradation entirely white image as the projection image P, the first marker pattern K1 and the second marker pattern K2 cannot be generated. Therefore, when a 100%-gradation image is displayed as the projection image P, the marker contrast has a minimum value of 1.0, so that the marker pattern MK cannot be generated in the projection image P.

The situation in the case of projecting a 0%-gradation projection image displayed in entirely black as the projection image P is the same as that in the case of projecting a 100%-gradation image displayed in entirely white. That is, when the gradation achieved by the first light modulating element 30 is set to 0%, the gradation achieved by the second light modulating element 40 also needs to be set to 0%. Neither the first marker pattern K1 nor the second marker pattern K2 can be generated. That is, when the projector 100 according to the present embodiment projects a 0%-gradation image displayed in entirely black as the projection image P, neither the first marker pattern K1 nor the second marker pattern K2 can be generated. Therefore, also when the gradation of the projection image P is set to 0%, the marker contrast has the minimum of 1.0, so that the marker pattern MK cannot be generated in the projection image P.

When the 80%-gradation gray image is projected as the projection image P as described above, the marker contrast is 1.7 as shown in FIG. 4. FIG. 4 shows that the marker contrast decreases in accordance with the gradation of the projection image P. Specifically, when the gradation of the projection image P is 50%, the marker contrast is 500, which is the maximum, and the marker contrast successively decreases to 400, 300, 200, and 100 as the gradation decreases to 40%, 30%, 20%, and 10%.

FIG. 5 shows the relationship between the gradation of the projection image P and the marker contrast. FIG. 5 shows the first image modulated light L1 and the second image modulated light L2 in a case where the marker pattern MK containing multiple circles arranged in a matrix is embedded in projection images P that gradually change from a 0%-gradation image displayed in entirely black to a 100%-gradation image displayed in entirely white from left to right.

Since the marker contrast is low as shown in FIG. 4 in a region of the first image modulated light L1 that is the region corresponding to a left-end region displayed in entirely black (0% gradation) or a right-end region displayed in entirely white (100% gradation) of the projection image P, the visibility of the circles that constitute the first marker pattern K1 lowers, as shown in FIG. 5. In contrast, since the marker contrast gradually increases in a region of the first image modulated light L1 that is the region corresponding to the center of the projection image P in the rightward-leftward direction and displayed in gray, the visibility of the circles that constitute the first marker pattern K1 can be improved.

Since the marker contrast is low as shown in FIG. 4 in a region of the second image modulated light L2 that is the region corresponding to a left-end region displayed in entirely black (0% gradation) or a right-end region displayed in entirely white (100% gradation) of the projection image P, the visibility of the circles that constitute the second marker pattern K2 lowers, as in the case of the first image modulated light L1. In contrast, since the marker contrast gradually increases in a region of the second image modulated light L2 that is the region corresponding to the center of the projection image P in the rightward-leftward direction and displayed in gray, the visibility of the circles that constitute the second marker pattern K2 can be improved.

As described above, it is known that the gradation of the projection image P affects the marker contrast. The projector 100 according to the present embodiment therefore sets the gradation of the projection image P to a value greater than 0% but smaller than 100%, more desirably, sets the gradation of the projection image P to a value around 50%, so that the identifiability of the marker pattern MK in the projection image P is improved.

An example of the operation of the projector 100 according to the present embodiment will be subsequently described.

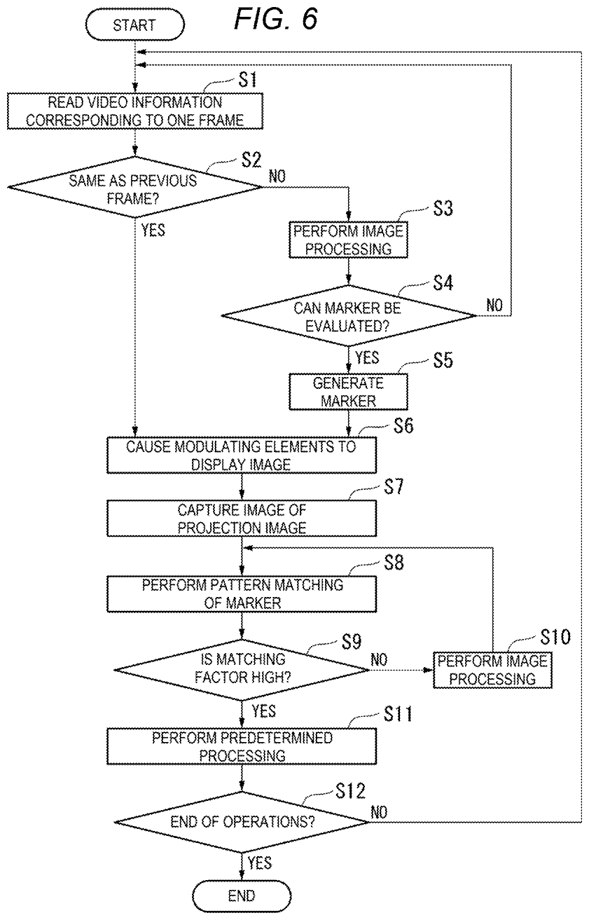

FIG. 6 shows an example of the procedure of the operations of the projector 100 according to the present embodiment. Note that the operations of the projector 100 are performed under the control of the controller 90.

Having started operating, the projector 100 according to the present embodiment reads video information corresponding to one frame as step S1, as shown in FIG. 6. Subsequently, as step S2, the controller 90 determines whether the read video information is the same as that corresponding to the previous frame. In step S2, when the video information is the same as that corresponding to the previous frame (YES in step S2), the controller 90 proceeds to step S6. Step S6 will be described later.

In step S2, when the video information is not the same as that corresponding to the previous frame (NO in step S2), the controller 90 proceeds to step S3. In step S3, the controller 90 performs predetermined image processing on the video information. As the predetermined image processing, for example, the controller 90 performs the processing of reflecting a luminance value corresponding to a display mode selected by the user in the video information. Examples of the display mode selected by the user may include a “dynamic mode” suitable for viewing in a bright environment, a “living mode” suitable for viewing in dim light, a “natural mode” capable of reproducing an image faithful to an input signal in a dark environment, and a “theater mode” suitable for movie viewing in a dark environment.

After step S3, the controller 90 proceeds to step S4. In step S4, the controller 90 determines whether an image displayed in accordance with the video information is an image suitable for marker evaluation. For example, when the controller 90 determines that the displayed image is an image suitable for evaluation of a marker having a high marker contrast of about 50% gradation (YES in step S4), the controller 90 proceeds to step S5. In step S5, the controller 90 generates a marker pattern to be embedded in the displayed image. For example, when the controller 90 determines that the displayed image is an image not suitable for evaluation of a marker having a low marker contrast of 0% or 100% gradation (NO in step S5), the controller 90 returns to step S1.

After step S5, the controller 90 proceeds to step S6. In step S6, the controller 90 causes the first light modulating element 30 and the second light modulating element 40 to display an image. Specifically, the controller 90 causes the first light modulating element 30 to modulate incident light to generate the first image modulated light L1 containing the first marker pattern K1, and causes the second light modulating element 40 to modulate incident light to generate the second image modulated light L2 containing the second marker pattern K2. The first image modulated light L1 and the second image modulated light L2 are thus combined with each other into the projection image P, which is then projected onto the screen SCR.

After completion of step S6, the controller 90 proceeds to step S7. In step S7, the imager 200 captures an image of the projection image P on the screen SCR. For example, the imager 200 images the first image modulated light L1 contained in the projection image P as the marker image MG, and transmits the result of the imaging to the controller 90.

Subsequently, in step S8, the controller 90 performs pattern matching of the marker in the captured marker image MG. Thereafter, in step S9, the controller 90 determines whether the marker is located at a place where the marker is readily recognized in the marker image MG. When the marker is located at a place where it is difficult to recognize the marker in the marker image MG (NO in step S9), the controller 90 determines that the matching factor is low, and proceeds to step S10.

In step S10, the controller 90 performs image processing for improving the marker recognition factor for the marker image MG captured by the imager 200. Examples of the image processing for improving the marker recognition factor include converting the marker image MG into grayscales, normalizing the gradation of the marker image MG, and the like. In step S10, a color filter may be disposed in front of the camera 202 of the imager 200 to adjust the tint itself of the marker image MG captured by the camera 202.

In step S9 described above, when the marker is located at a position where the marker is readily recognized in the marker image MG (YES in step S9), the controller 90 determines that the matching factor is high, and proceeds to step S11.

In step S11, the controller 90 estimates deviation of the position of the projection image P on the screen SCR based on the marker image MG, and corrects the deviation of the position of the projection image P on the screen SCR based on the result of the estimation. The projection image P on the screen SCR may change over time due to the influence of heat generated in the projection optical apparatus 70, the light combiner 50, the first light modulating element 30, and the second light modulating element 40.

Specifically, in step S11, the controller 90 controls the shift mechanism 60 based on the marker image MG captured by the imager 200. The controller 90 operates the shift mechanism 60 based on the result of the estimation of the position of the projection image P, and moves the projection optical apparatus 70 in a direction in which the deviation of the position of the projection image P is corrected.

In step S11, the controller 90 may change the region of the image formed in the image display region of each of the first light modulating element 30 and the second light modulating element 40 based on the marker image MG. In this case, based on the result of the estimation of the position of the projection image P, the controller 90 causes the first light modulating element 30 and the second light modulating element 40 to form a projection image P with the deviation of the position corrected to correct the deviation of the position of the projection image P on the screen SCR.

Subsequently, in step S12, to terminate the operations of the projector 100 (YES in step S12), the controller 90 terminates the operation procedure. To continue the operations of the projector 100 (NO in step S12), the controller 90 returns to step S1 and repeats the operation procedure.

As described above, the projector 100 according to the present embodiment includes the light source apparatus 10, which outputs the multiple types of color light having the three primary colors in a time division manner, the polarization separator 20, which separates the light output from the light source apparatus 10 into the S-polarized light and the P-polarized light, the first light modulating element 30, which modulates the S-polarized light separated by the polarization separator 20, the second light modulating element 40, which modulates the P-polarized light separated by the polarization separator 20, the light combiner 50, which combines the first image modulated light L1 output from the first light modulating element 30 and entering the light combiner 50 with the second image modulated light L2 output from the second light modulating element 40 and entering the light combiner 50 in a direction different from the direction in which the first image modulated light L1 enters the light combiner 50 to generate the image light G, and the projection optical apparatus 70, which projects the image light G output from the light combiner 50. The first image modulated light L1 is P-polarized light containing the first marker pattern K1 configured with a predetermined bright and dark pattern, and the second image modulated light L2 is S-polarized light containing the second marker pattern K2 configured with a reversed bright and dark pattern that is a reversed version of the first marker pattern K1 in terms of the bright portions and the dark portions. The light combiner 50 combines the first image modulated light L1 and the second image modulated light L2 to each other in a way that the first marker pattern K1 and the second marker pattern K2 cancel out each other in the image light G.

The configuration of the projector 100 according to the present embodiment allows the image light G, in which the first marker pattern K1 and the second marker pattern K2, which function as markers, are embedded, to be projected onto the screen SCR.

In some cases, the position of the projection image P may be shifted over time due to the influence of the heat generated in the projection optical apparatus 70, the light combiner 50, the first light modulating element 30, and the second light modulating element 40. In contrast, the projector 100 according to the present embodiment, for example, captures an image of the projection image P via a polarizer that transmits only one type of polarized light to acquire marker information from the first marker pattern K1 or the second marker pattern K2, and can determine whether there is a deviation of the position of the projection image P based on the marker information, and correct the deviation of the position of the projection image P.

In the image light G, the first marker pattern K1 and the second marker pattern K2 cancel out each other. The user who visually recognizes the projection image P on the screen SCR cannot therefore identify the first marker pattern K1 or the second marker pattern K2. The configuration described above can therefore realize image projection that does not cause the user visually recognizing the projection image P to see unnecessary information and can therefore prevent the user from feeling something is wrong. The projector 100 according to the present embodiment does not cause the user visually recognizing the projection image P to see unnecessary marker information and can therefore prevent the user from feeling something is wrong.

The configuration of the projector 100 according to the present embodiment, in which the marker pattern is embedded in the image light G to be projected onto the screen SCR, eliminates the need to separately dispose a light source, an optical system, and other elements that generate the marker pattern. An increase in size and weight caused by providing a light source and an optical system for pattern generation can thus be suppressed.

The configuration of the projector 100 according to the present embodiment, in which information on the position of the projection image P can be accurately detected based on the marker pattern acquired from the projection image P on the screen SCR, is also suitable, for example, for an application in which projection images from multiple projectors are superimposed on each other and displayed on the screen SCR and the projection images are aligned with each other.

The projector 100 according to the present embodiment is also suitable for an amusement application such as a game in which the user is notified of information based on the marker pattern when the user wearing polarized glasses visually recognizes the projection image P on the screen SCR.

In the configuration of the projector 100 according to the present embodiment, color light output from a light source apparatus is not separated in terms of color, as can be seen in what is called a three-plate or two-plate projector of related art, but the color light output from the light source apparatus 10 is separated in terms of polarization into two kinds of polarized light along two optical paths, which can enter the first light modulating element 30 and the second light modulating element 40 along the respective optical paths. The projector 100 according to the present embodiment, unlike the projector of the related art, can therefore eliminate the need to dispose light-incident-side polarizers immediately upstream of the light modulators in the optical paths of the multiple types of color light, and avoid halving the brightness of the image light due to the presence of the light-incident-side polarizers, and generation of color light blocked as unnecessary light before entering the light modulators. The projector 100 according to the present embodiment can suppress loss of the color light in the portion upstream of the first light modulating element 30 and the second light modulating element 40 in the optical path of the color light to improve the light use efficiency, reduce the number of parts such as the light-incident-side polarizers used in the related art, so that an increase in size of the projector 100 can be suppressed.

The projection system 1000 according to the present embodiment includes the projector 100 described above, and the imager 200, which captures an image of the projection image P projected from the projector 100. The projector 100 further includes the shift mechanism 60, which moves the projection optical apparatus 70 to change the position of the projection image P, and the controller 90, which controls the shift mechanism 60 based on the image captured by the imager 200.

In the projection system 1000 according to the present embodiment, the controller 90 can control the shift mechanism 60 based on the image captured by the imager 200 to move the projection optical apparatus 70 in a direction in which the deviation of the position of the projection image P is corrected. The deviation of the position of the projection image P on the screen SCR that occurs over time can therefore be appropriately corrected.

The projection system 1000 according to the present embodiment performs image processing for improving the marker recognition factor for the captured marker image based on the result of the imaging performed by the imager 200. The projection system 1000 according to the present embodiment can acquire information on the position of the projection image P with high accuracy by improving the marker recognition factor for the marker image. The deviation of the position of the projection image P on the screen SCR can therefore be corrected with high accuracy.

### First Variation

For example, the procedure of the operations of the projector is not limited to the procedure shown in FIG. 6. A variations of the operation procedure will be described below.

In the present variation, when it is determined that the marker matching factor is low in step S9 shown in FIG. 6, the controller 90 may return to step S5 instead of performing the image processing in step S10, and may regenerate the marker pattern MK to be embedded in the projection image P.

In this case, the controller 90 changes the shape of the first marker pattern K1 and the position where the first marker pattern K1 is formed in the first image modulated light L1, and the shape of the second marker pattern K2 and the position where the second marker pattern K2 is formed in the second image modulated light L2. For example, when the entire display screen is almost white as in a display screen of spreadsheet software (Microsoft Corporation: Excel (registered trademark)) or the like, and a region where a marker pattern is highly identifiable is present at only a portion of the display screen, such as a region where icons and other figures are displayed is present in an upper portion of the display screen, as in the case of marker pattern MK in the projection image P, the controller 90 controls the first light modulating element 30 and the second light modulating element 40 to cause them to each modulate the image modulated light containing a marker pattern having an appropriate shape that allows the marker to overlap with a figure display portion that is a region where the marker pattern MK is highly identifiable.

According to the operation procedure of the present variation, the marker pattern MK can be optimized based on feedback of the result of the imaging performed on the projection image P. The marker recognition factor for the marker imaged by the imager 200 can therefore be improved without performing image processing on the marker image.

In the projector 100 according to the embodiment described above, the first light modulating element 30 modulates each of the blue light BL, the green light GL, and the red light RL incident in a time division manner to generate the first image modulated light L1 containing the first marker pattern K1, but not necessarily in the present disclosure.

### Second Variation

A description will be made as a second variation with reference to a case where a marker pattern is formed in image light formed from part of the color light output in a time division manner but no marker pattern is formed in the image light formed from the remaining color light.

In the present variation, first image modulated light containing a first marker pattern is generated when part of the blue light BL, the green light GL, and the red light RL is modulated, and image modulated light containing no first marker pattern is generated when the remaining part of the blue light BL, the green light GL, and the red light RL is modulated. Furthermore, second image modulated light containing a second marker pattern is generated when part of the blue light BL, the green light GL, and the red light RL is modulated, and image modulated light containing no second marker pattern is generated when the remaining part of the blue light BL, the green light GL, and the red light RL is modulated.

Specifically, the first light modulating element 30 in the present variation modulates the S-polarized light of the blue light BL to output the first image modulated light L1, and modulates the S-polarized light of the green light GL to output first green modulated light (third modulated light) that does not contain the first marker pattern K1 and is P-polarized light. The first light modulating element 30 further modulates the S-polarized light of the red light RL to output first red modulated light that does not contain the first marker pattern K1 and is P-polarized light.

The second light modulating element 40 modulates the P-polarized light of the blue light BL to output the second image modulated light L2, and modulates the P-polarized light of the green light GL to output second green modulated light (fourth modulated light) that does not contain the second marker pattern K2 and is P-polarized light. The second light modulating element 40 further modulates the P-polarized light of the red light RL to output second red modulated light that does not contain the second marker pattern K2 and is P-polarized light.

The light combiner 50 combines the first image modulated light L1 and the second image modulated light L2 with each other to generate blue image light containing a marker pattern, combines the first green modulated light and the second green modulated light with each other to generate green image light containing no marker pattern, and combines the first red modulated light and the second red modulated light with each other to generate red image light containing no marker pattern.

The light combiner 50 in the present variation can thus output the blue image light containing a marker pattern, the green image light containing no marker pattern, and the red image light containing no marker pattern in a time division manner.

The configuration in the present variation, in which a marker pattern is selectively formed in the blue image light, which is less visible to human eyes, but no marker pattern is selectively formed in the green image light, which is more visible to human eyes, can make it difficult for the user to visually recognize the marker pattern.

The technical scope of the present disclosure is not limited to the embodiment described above, and a variety of changes can be made thereto to an extent that the changes do not depart from the intent of the present disclosure. As an aspect of the present disclosure, the characteristic portions in the embodiments described above can be combined with each other as appropriate.

The present disclosure is also applicable to a sequentially-scanning-illumination-type color display projector in which two light modulating elements are scanned with illumination light with the aid of a rotating prism and the light modulating elements are driven in synchronization with the color of the incident illumination light.

The present disclosure can also be applied to a laser-scanning-type projector in which a light modulating element is scanned with laser light without using a rotating prism.

### SUMMARY OF PRESENT DISCLOSURE

The present disclosure will be summarized below in the form of additional remarks.

### Additional Remark 1

A projector including:
a light source apparatus configured to output light;
a polarization separator configured to separate the light output from the light source apparatus into first polarized light and second polarized light polarized in a direction different from a direction in which the first polarized light is polarized;
a first light modulating element configured to modulate the first polarized light separated by the polarization separator;
a second light modulating element configured to modulate the second polarized light separated by the polarization separator,
a light combiner configured to combine first modulated light output from the first light modulating element and entering the light combiner with second modulated light output from the second light modulating element and entering the light combiner incident in a direction different from a direction in which the first modulated light enters the light combiner to generate image light; and
a projection optical apparatus configured to project the image light output from the light combiner,
wherein the first modulated light is light polarized in the same direction as the second polarized light containing a first marker pattern configured with a predetermined bright and dark pattern,
the second modulated light is light polarized in the same direction as the first polarized light containing a second marker pattern configured with a reversed bright and dark pattern that is a reversed version of the first marker pattern in terms of bright portions and dark portions, and
the light combiner is configured to combine the first modulated light and the second modulated light with each other in a way that the first marker pattern and the second marker pattern cancel out each other in the image light.

The thus configured projector can project the image light, in which the first marker pattern and the second marker pattern, which function as markers, are embedded, onto a projection receiving surface such as a screen. In some cases, the position of the projection image may be shifted over time due to the influence of heat generated in the projection optical apparatus, the light combiner, the first light modulating element, and the second light modulating element. In contrast, the configuration described above, in which for example, an image of the projection image is captured via a polarizer that transmits one of the first polarized light and the second polarized light, can acquire marker information from the first marker pattern or the second marker pattern, and determine whether there is a deviation of the position of the projection image based on the marker information, and correct the deviation of the position of the projection image.

Furthermore, since the first marker pattern and the second marker pattern cancel out each other in the image light, the user visually recognizing the projection image cannot identify the first marker pattern or the second marker pattern. The configuration described above can therefore realize image projection that does not cause the user visually recognizing the projection image to see unnecessary information and can therefore prevent the user from feeling something is wrong.

The configuration described above, in which the marker pattern is embedded in the projection image light, eliminates the need to separately dispose a light source, an optical system, and other elements that generate the marker pattern. An increase in size and weight caused by providing a light source and an optical system for pattern generation can thus be suppressed.

The configuration described above, in which information on the position of the projection image can be accurately detected based on the marker pattern acquired from the projection image, is suitable, for example, for an application in which projection images from multiple projectors are superimposed on each other and displayed on a projection receiving surface and the projection images are aligned with each other. The configuration described above is also suitable, for example, for an amusement application such as a game in which a user wearing polarized glasses and visually recognizing the projection image is notified of information based on the marker pattern.

### Additional Remark 2

The projector according to Additional Remark 1, wherein
the light source apparatus is configured to output first light in a first wavelength band, second light in a second wavelength band different from the first wavelength band, and third light in a third wavelength band different from the first wavelength band and the second wavelength band in a time division manner,
the first light modulating element is configured to modulate the first polarized light of each of the first light, the second light, and the third light,
the second light modulating element is configured to modulate the second polarized light of each of the first light, the second light, and the third light, and
a timing at which the first light modulating element modulates the first polarized light in a predetermined wavelength band is the same as a timing at which the second light modulating element modulates the second polarized light in the predetermined wavelength band.

According to the configuration described above, the timing at which the first light, the second light, and the third light are output from the light source apparatus in a time division manner and the timing at which the multiple types of modulated light of the first light, second light, and third light are output from the first and second light modulating elements can be readily controlled.

### Additional Remark 3

The projector according to Additional Remark 1 or 2, further including:
a first light-exiting-side polarizer disposed between the first light modulating element and the light combiner; and a second light-exiting-side polarizer disposed between the second light modulating element and the light combiner.

According to the configuration described above, the contrast ratio between the first modulated light and the second modulated light can be improved.

### Additional Remark 4

The projector according to Additional Remark 1 or 2, wherein
the light source apparatus is configured to output first light in a first wavelength band and second light in a second wavelength band different from the first wavelength band in a time division manner,
the first light modulating element is configured to modulate the first polarized light of the first light to output the first modulated light, and modulate the first polarized light of the second light to output third modulated light that does not contain the first marker pattern and is polarized in the same direction as the second polarized light,
the second light modulating element is configured to modulate the second polarized light of the first light to output the second modulated light, and modulates the second polarized light of the second light to output fourth modulated light that does not contain the second marker pattern and is polarized in the same direction as the first polarized light, and
the light combiner is configured to combine the third modulated light and the fourth modulated light with each other to generate the image light.

According to the configuration described above, a projector that outputs image light that belongs to the first wavelength band and contains a marker pattern and image light that belongs to the second wavelength band and contains no marker pattern in a time division manner can be achieved.

### Additional Remark 5

The projector according to Additional Remark 4, wherein
the first light is blue light, and the second light is green light.

The configuration described above, in which a marker pattern is selectively formed in the blue image light, which is less visible to human eyes, but no marker pattern is selectively formed in the green image light, which is more visible to human eyes, can make it difficult for the user to visually recognize the marker pattern.

### Additional Remark 6

A projection system including:
the projector according to any one of Additional Remarks 1 to 5; and
an imager configured to image one of the first modulated light and the second modulated light contained in the image light projected from the projector,
wherein the projector is configured to change a shape of the first marker pattern and a position where the first marker pattern is formed in the first modulated light, and a shape of the second marker pattern and a position where the second marker pattern is formed in the second modulated light based on a result of the imaging performed by the imager.

According to the thus configured projection system, the marker pattern can be optimized based on feedback of the result of the projection. The marker recognition factor for the marker imaged by the imager can therefore be improved without performing image processing on the captured image.

### Additional Remark 7

A projection system including:
the projector according to any one of Additional Remarks 1 to 5; and
an imager configured to image one of the first modulated light and the second modulated light contained in the image light projected from the projector,
wherein the projector is configured to perform predetermined image processing on the captured image based on a result of the imaging performed by the imager.

According to the configuration described above, for example, image processing for improving the marker recognition factor can be performed on the image captured by the imager. The accuracy of the detection of the marker pattern formed in the projection image can therefore be improved.

### Additional Remark 8

A projection system including:
the projector according to any one of Additional Remarks 1 to 5; and
an imager configured to image one of the first modulated light and the second modulated light contained in the image light projected from the projector,
wherein the projector includes
a moving mechanism configured to move the projection optical apparatus to change a position where the image light is projected, and
a controller configured to control the moving mechanism based on a result of the imaging performed by the imager.

According to the configuration described above, the controller can control the moving mechanism based on an image captured by the imager to move the projection optical apparatus in a direction in which deviation of the position of the projection image is corrected. The deviation of the position of the projection image that occurs over time can therefore be appropriately corrected.

What is claimed is:

1. A projector comprising:
a light source apparatus configured to output light;
a polarization separator configured to separate the light output from the light source apparatus into first polarized light and second polarized light polarized in a direction different from a direction in which the first polarized light is polarized;
a first light modulating element configured to modulate the first polarized light separated by the polarization separator;
a second light modulating element configured to modulate the second polarized light separated by the polarization separator,
a light combiner configured to combine first modulated light output from the first light modulating element and entering the light combiner with second modulated light output from the second light modulating element and entering the light combiner incident in a direction different from a direction in which the first modulated light enters the light combiner to generate image light; and
a projection optical apparatus configured to project the image light output from the light combiner,
wherein the first modulated light is light polarized in the same direction as the second polarized light containing a first marker pattern configured with a predetermined bright and dark pattern,
the second modulated light is light polarized in the same direction as the first polarized light containing a second marker pattern configured with a reversed bright and dark pattern that is a reversed version of the first marker pattern in terms of bright portions and dark portions, and
the light combiner is configured to combine the first modulated light and the second modulated light with each other in a way that the first marker pattern and the second marker pattern cancel out each other in the image light.

2. The projector according to claim 1, wherein
the light source apparatus is configured to output first light in a first wavelength band, second light in a second wavelength band different from the first wavelength band, and third light in a third wavelength band different from the first wavelength band and the second wavelength band in a time division manner,
the first light modulating element is configured to modulate the first polarized light of each of the first light, the second light, and the third light,
the second light modulating element is configured to modulate the second polarized light of each of the first light, the second light, and the third light, and
a timing at which the first light modulating element modulates the first polarized light in a predetermined wavelength band is the same as a timing at which the second light modulating element modulates the second polarized light in the predetermined wavelength band.

3. The projector according to claim 1, further comprising:
a first light-exiting-side polarizer disposed between the first light modulating element and the light combiner; and a second light-exiting-side polarizer disposed between the second light modulating element and the light combiner.

4. The projector according to claim 1, wherein
the light source apparatus is configured to output first light in a first wavelength band and second light in a second wavelength band different from the first wavelength band in a time division manner,
the first light modulating element is configured to modulate the first polarized light of the first light to output the first modulated light, and modulate the first polarized light of the second light to output third modulated light that does not contain the first marker pattern and is polarized in the same direction as the second polarized light,
the second light modulating element is configured to modulate the second polarized light of the first light to output the second modulated light, and modulates the second polarized light of the second light to output fourth modulated light that does not contain the second marker pattern and is polarized in the same direction as the first polarized light, and
the light combiner is configured to combine the third modulated light and the fourth modulated light with each other to generate the image light.

5. The projector according to claim 4, wherein
the first light is blue light, and the second light is green light.

6. A projection system comprising:
the projector according to claim 1; and
an imager configured to image one of the first modulated light and the second modulated light contained in the image light projected from the projector,
wherein the projector is configured to change a shape of the first marker pattern and a position where the first marker pattern is formed in the first modulated light, and a shape of the second marker pattern and a position where the second marker pattern is formed in the second modulated light based on a result of the imaging performed by the imager.

7. A projection system comprising:
the projector according to claim 1; and
an imager configured to image one of the first modulated light and the second modulated light contained in the image light projected from the projector,
wherein the projector is configured to perform predetermined image processing on the captured image based on a result of the imaging performed by the imager.

8. A projection system comprising:
the projector according to claim 1; and
an imager configured to image one of the first modulated light and the second modulated light contained in the image light projected from the projector,
wherein the projector includes
a moving mechanism configured to move the projection optical apparatus to change a position where the image light is projected, and
a controller configured to control the moving mechanism based on a result of the imaging performed by the imager.
